(19) United States
(12) Patent Application Publication
(10) Pub. No.: US 2010/0066118 A1
(43) Pub. Date: Mar. 18, 2010

(54) Insect Screen

(76) Inventors: Shu-Lan Miller, San Bernardino, CA (US); Edward Miller, San Bernardino, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/212,471

(22) Filed: Sep. 17, 2008

(51) Int. Cl. B60J 7/00

(52) U.S. Cl. 296/107.11

(57) ABSTRACT

The present invention is an insect screen for golf style carts and the like. The insect screen is a mesh rectangle with double fold-quilted edge for reinforcement. There are brass grommets in each corner to hold stretchable cords with movable hooks to hold the insect screen across the front of a golf cart. The insect screen also has hook and loop fasteners in the middle of each side to attach around the poles of a golf style cart. Due to the hook and loop closures and the stretchable cords the insect screen has a taunt fit to the front of the golf style cart and will protect the riders in the golf style cart from stray balls coming at the vehicle. The insect screen is washable and easy to install, remove, and store.

### FIELD OF THE INVENTION

The present invention relates to an attachable and removable screen that protects golfers from insects and stray golf balls.

### BACKGROUND OF THE INVENTION

Most golf style carts available at golf courses have no windshields and no protective covers on the front of the vehicle. This can lead to injuries due to stray golf balls on the course coming into the vehicle. Also during golf season there are flying insects that are out of hibernation and in their reproductive season in the same time of year. Golfers need a way to protect themselves from insects in golf carts.

U.S. Pat. No. 6,264,570 issued to Yoon, on Jul. 24, 2001 shows a practice sports net. Yoon's invention is unlike the present invention because it is not intended to shield golfers in a golf cart, it is a driving net, and is not intended for use on golf carts as a insect shield.

U.S. Pat. No. 5,989,130 issued to Macaluso, on Nov. 23, 1999 shows a multi-use net. Macaluso's invention is unlike the present invention because it is a practice net for driving, it is not intended to shield golfers in a golf cart, and is not intended to attach to a golf cart to act as an insect shield to the passengers.

U.S. Pat. No. 5,947,831 issued to McCarthy on Sep. 7, 1999, shows a target for golf practice. McCarthy's invention is unlike the present invention because it is a practice net for driving, it is not intended to fit on a golf cart, and it cannot act as a insect shield on a golf cart.

U.S. Pat. No. 5,788,317 issued to Nation on Aug. 4, 1998, shows a dual paneled golf cart enclosures. Nation's invention is unlike the present invention because it shows a two layered cover for golf carts. The cover includes a layer of mesh and a layer of vinyl, and covers the entire vehicle instead of the front opening only. Nation's invention cannot, because of its structure, fit in a taut manner across the front of the golf cart, and does not have stretchable cords to allow it to fit in a tight manner like a windshield.

U.S. Pat. No. 5,451,445 issued to Wang on Sep. 19, 1995 shows a foldable net assembly. Wang's invention is unlike the present invention because it is a net for use over budding plants as in a garden. Wang's invention would not function as a bug screen for golf carts.

U.S. Pat. No. 5,393,118 issued to Welborn on Feb. 28, 1998 issued to aluminum framed vinyl closure for golf carts. Welborn's invention is unlike the present invention because it is intended to be a permanent addition to the existing golf cart frame. Welborn's invention is made of a solid not mesh material, fits around all exposed areas of the golf cart, and does not allow the golfers to enjoy a breeze through the sides of the golf cart as it covers all sides. Also, Welborn's invention is not machine washable.

U.S. Pat. No. 5,229,746 issued to Healy, et al., on Jul. 20, 1993 shows a vehicle wind screen light assembly. Healy's invention is unlike the present invention because it is a partial windscreen that does not cover the entirety of the front of the golf cart, and therefore would not protect the golfers from oncoming insects. Also Healy's invention is not a mesh material that tightly covers the front of the golf cart, and is intended to be a permanent mounting to the golf cart and is not easily removed.

U.S. Pat. No. 5,211,214 issued to Shaw on May 18, 1993 shows a golf cart window apparatus. Shaw's invention is unlike the present invention because it has no stretchable cord attachments to allow the users to easily remove the screen. Instead, Shaw's invention is permanently attached to the golf cart, by use of L-plates and screws.

U.S. Pat. No. 4,836,598 issued to Mastin on Jun. 6, 1989 shows an insect screen apparatus for vehicles. Mastin's invention is unlike the present invention because it is a partial insect shield to sit on an automobile's hood above the headlights. Mastin's invention is intended to be permanently affixed to the automobile, would not fit properly on golf carts, and does not cover the entire front section of a golf cart.

U.S. Pat. No. 4,932,714 issued to Chance on Jun. 12, 1990 shows a demountable door for golf cart or the like. Chance's invention is unlike the present invention because it is a clear door for attaching to the side of the golf cart. Chance's invention would not protect golfers from oncoming golf balls, or insects.

U.S. Pat. No. 4,776,627 issued to Hutto, et al., on Oct. 11, 1988 shows a wind deflector and bug screen clip. Hutto's invention is unlike the present invention because it is a small clear bug shield that is intended to fit across the hood of automobiles, and it would not cover the entire front section of a golf cart. Also it would not protect the golfer from insects because it does not cover the entire screen. Additionally, Hutto's invention is not machine washable as is the mesh of the present invention, and is attached by screw and snapping closures, not stretchable cords and hook and loop material as the present invention.

U.S. Pat. No. 3,860,022 issued to Arndt, et al., on Jan. 14, 1975 shows a mosquito and insect umbrella. Arndt's invention is unlike the present invention because it is a tent like item for fitting over outdoor tables for picnics or other outdoor activities. Arndt's invention would not function as a mesh windshield for a golf cart, and would not protect golfers from fly away golf balls, or oncoming insects.

U.S. Pat. No. 3,753,458 issued to Lazarek, on Aug. 21, 1973 shows a demountable car window screen and fastening means therefore. Lazarek's invention is unlike the present invention because it is a hook and loop fastener system to cover a car window so the user may leave the window in an open position in warmer months without insects invading the car. Lazarek's invention does not have stretchable cord attachments; it would not protect golfers from oncoming insects in a golf cart, and cannot be applied in a taut manner to a golf cart to protect golfers from oncoming golf balls. Also Lazarek's invention would not fit on the front section of a golf cart.

U.S. Design Pat. no. 338,966, issued to Pinard, shows a garage door bug screen. Pinard's invention is unlike the present invention because it is a rolling screen design, like a window screen, and has an upper crank mechanism. Pinard's invention would not function as a cover for the front open section of a golf cart, and could not protect golfers from flying golf balls, or oncoming insects while in a golf cart.

Japanese Patent no. 07217340 issued to Sadao, on Feb. 7, 1994 shows an insect proof wire screen. Sadao's invention is unlike the present invention because it is intended for a window in a home or building, it is not made of a pliable mesh material, it also would not function for attachment to the front section of a golf cart, and is not machine washable.

United Kingdom Patent no. 6,276,745 issued to Wilson, on Aug. 21, 2001 shows a golf cart enclosure. Wilson's invention is unlike the present invention because it is a golf cart assembly with adjacent rods and a cover; it does not supply a mesh cover for the front of a golf cart. Wilson's invention is a total cover for the golf cart, and does not allow the user to enjoy the breeze through the sides of a golf cart as does the present invention, and is more complicated to install then the present invention. Also, it does not have a stretchable cord mechanism to hold the screen in a taut manner, and it is clear in nature not a mesh screen.

### SUMMARY OF THE INVENTION

The present invention is an insect screen device for golf style carts. There is a mesh rectangle that is removable from the vertical supports along two edges that allow the user to keep the present invention straight and wrinkle free during application. Stretchable cords run horizontally in conjunction with the top and bottom hems of the present invention. The stretchable cords attach around the vertical supports of the golf style cart in the front and are adjustable to insure a tight fit. The mesh rectangle also has hook and loop closures that are in the middle of two sides to allow the user to fit the present invention tightly in the middle.

The present invention protects the golfers from stray balls or insects coming toward the vehicle. The tight manner that the screen fits across the front of the golf style cart allows for a screen between the golfers and oncoming objects. The stretchable cord attachments allow the golfer to easily attach and detach the present invention, thereby allowing use by golfers that do not own their own golf carts.

### BRIEF DESCRIPTION OF THE DRAWINGS

FIG. 1 shows a top view of the present invention.

### DETAILED DESCRIPTION OF THE PREFERRED EMBODIMENT(S)

The present invention is a mesh screen to fit across the front of a golf style cart, stretching from one horizontal support of the golf style cart to the other. The components of the present invention include a rectangular mesh screen, stretchable cords, communication hooks on the stretchable cords, hook and loop fasteners.

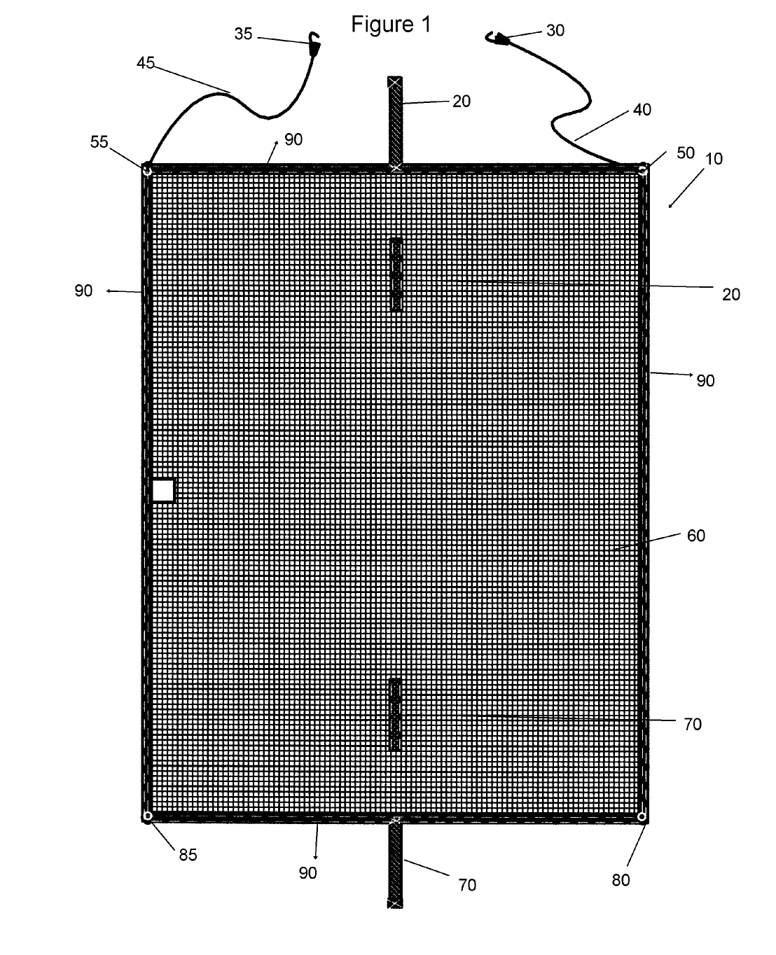

Turning to FIG. 1, we have a clear top view of the insect screen (10). The insect screen (10) has a first stretchable cord (40) and a second stretchable cord (45). Each of the stretchable cords (40, 45) is fed through a first hole (50) and a second hole (55), respectively, at two corners of the mesh rectangle (60). Each of the stretchable cords (40, 45) has communicating hooks (30, 35) that ensure a tight fit of the mesh rectangle (60) to the golf cart (not shown). The first communicating hook (30) is hooked around the poles of the golf cart (not shown) along the back of the mesh rectangle (60) to the third hole (80) disposed opposite the first hole (50). The second communicating hook (35) fits around the poles of the golf cart (not shown), along the back of the mesh rectangle (60) to the fourth hole (85) disposed opposite the second hole (55). The mesh rectangle (60) creates a screen from insects and flying balls on the front of a golf cart (not shown).

Also inherent in the present invention are first hook and loop fastener (20) and a second hook and loop fastener (70). The first and second hook and loop fasteners (20, 70) close in a secure yet removable fashion around the middle of the poles of the golf style cart (not shown). The first and second stretchable cords (40, 45), first and second communicating hooks (30,35), and the first and second hook and loop fasteners (20, 70) allow the user to secure the insect screen in a tight manner around the top, bottom and sides of the mesh rectangle (60). The first and second stretchable cords (40,45) stretch to allow the user to tightly fasten the first and second communicating hooks (30,35) to the third and fourth holes (80,85).

The insect screen (10) is easily attached to the golf style cart (not shown) and takes little amount of space to store. In order to apply the insect screen (10), the user would: stretch the mesh rectangle (60) across and between the left and right supports of the golf styled cart and pull the stretchable cords (40, 45) around the right pole of the golf styled cart and across the back of the mesh rectangle (60) and place the communicating hooks (30, 35) into locked position around the left pole and into the third and fourth holes (80,85). The stretchable cords (40,45) create a tight yet pliable fit for the mesh rectangle (60) to the golf style cart (not shown). Next, the user would attach the first hook and loop attachment (20) around the right pole of the golf styled cart. Lastly, the user would attach the second hook and loop attachment (70) to the left pole of the golf styled cart.

In combination with the hook and loop fasteners (20, 70) the stretchable cords (40,45) and communicating hooks (30,35) allow the mesh rectangle (60) to be tight enough to protect the golfers from stray balls, and flying insects. Folds or wrinkles in the screen are smoothed out by use of the stretchable cords (40, 45) and the first and second hook and loop attachments (20,70). The mesh rectangle (60) will flex a bit at the top and bottom due to the stretchable cords (40,45), but is held tight in the middle due to the hook and loop fasteners (20,70). Therefore, the users do not need to worry about being hit in the head area by flying golf balls or flying insects from the front of the cart while riding in the golf style cart, which can lead to great injury.

The first and second stretchable cords (40,45) have elasticity to stretch from one side of the golf style cart to the opposite without breaking or compromising their strength. The stretchable cords (40,45) can fit to any golf style cart width due to the aforementioned elasticity. The stretchable cords (40,45) which allows them to grip the poles of the golf style cart, and stay in place once installed. The grip of the stretchable cords (40,45) allows the cords to stay in place and slide up or down the poles of the golf cart. The grip of the stretchable cords (40,45) further protects the golfers upon impact of a golf ball to the mesh rectangle (60), as they provide additional support in conjunction with the first and second hook and loop attachments (20,70).

The mesh rectangle (60) in the preferred embodiment is 46 inches wide by 36 inches high, by ⅛ inches thick. The hook and loop fasteners (20,70) are 6.5 inches long by 1 inch wide. When measured in terms of thickness in combination with the mesh rectangle (60), the hook and loop fasteners (20,70) are approximately ⅛ inches thick each. The first and second stretchable cords (40, 45) are 0.25 inches in diameter and are 21 inches long in their relaxed or non-stretched state. When measured in terms of thickness in combination with the mesh rectangle (60), the first an second stretchable cords (40, 45) are ½ inch thick each. The first and second stretchable cords (40, 50) each have an end of 2.5-3 inches that is inserted into the first and second movable hooks (30,35). The first and second stretchable cords (40, 45) each have movable hooks (30, 35). The first and second movable hooks (30, 35) can be released and moved along the first and second stretchable cords (40,45). The first and second communicating hooks (30,35) are ⅝ inches in length, and are steel hooks covered in a black rubber for weatherproofing. It also should be noted that the dimensions described above are merely the preferred embodiment.

The first and second communicating hooks (30,35) attached to the stretchable cords (40, 45) allow for a tight fit if the golf style cart (not shown) has a smaller width than standard golf carts. Also the stretchable cords (40,45) allow for a tight fit on the golf style cart (not shown) has a larger width than standard golf carts. The first, second, third and fourth holes (50, 55, 80, 85) are attached to the 2 inch folded the mesh rectangle (60) by a C clamp brass grommet to reinforce the first, second, third, and fourth holes (50,55,80,85). The first and second hook and loop fasteners (20, 70) each have a 0.5 inch gripping section at their end, to allow the user to easily attach the insect screen (10) to the golf cart (not shown). The mesh rectangle (60) has a double fold quilted edge (90) to reinforce the edges and hold the C clamp brass grommet. The double fold quilted edge (90) is 46 inches across the top edge, and 36 inches down the length of the insect screen (10).

The present invention also can be said to work as follows. The user may feed a first stretchable cord (40) and a second stretchable cord (45) through a first hole (50) and a second hole (55), respectively, at two corners of the mesh rectangle (60). The first stretchable cord (40) and a second stretchable cord (45) are formed to hold hooks (30, 35). The user can then tightly fit the mesh rectangle (60) to the golf cart. This is done by hooking the first communicating hook (30) around the poles of the golf cart (not shown) along the back of the mesh rectangle (60) to the third hole (80) disposed opposite the first hole (50). The second communicating hook (35) is fitted around the poles of the golf cart (not shown), along the back of the mesh rectangle (60) to the fourth hole (85) disposed opposite the second hole (55). The mesh rectangle (60) screens and prevents insects and flying balls from impeding on the immediate space at the front of a golf cart (not shown). It also should be noted that the first and second hook and loop fasteners (20, 70) are closed in a secure yet removable fashion around the middle of the poles of the golf style cart (not shown). The first and second stretchable cords (40, 45), first and second communicating hooks (30,35), and the first and second hook and loop fasteners (20, 70) are secured by the user to the insect screen (10) in a tight manner around the top, bottom and sides of the mesh rectangle (60). The first and second stretchable cords (40,45) also are stretched to allow the user to tightly fasten the first and second communicating hooks (30,35) to the third and fourth holes (80,85). The user also attaches the insect screen (10) to the golf cart. In addition, the user can remove the insect screen (10) and store the insect screen (10) in a compact location.

We claim:

1. A protective screen, comprising:
feeding a first stretchable cord and a second stretchable cord through a first hole and a second hole, respectively, at two corners of a mesh rectangle;
forming the first stretchable cord and the second stretchable cord to be configured to hold a first communicating hook and a second communicating hook;
fitting the mesh rectangle to a golf cart by hooking the first communicating hook around the poles of the golf cart along the back of the mesh rectangle to a third hole disposed opposite the first hole;
fitting the second communicating hook around poles of the golf cart along a back of the mesh rectangle to a fourth hole disposed opposite the second hole;
screening occupants of a golf cart from hazards and nuisances impeding on the immediate space at the front of the golf cart;
closing the first hook and the second hook with a first loop fastener and a second loop fastener in a secure fashion around a middle of the poles of a golf cart;
securing the first stretchable cords, the second stretchable cord, the first communicating hook, the second communicating hook, the first hook, the second hook and loop fasteners to the insect screen in a tight manner around the top, a bottom and left side and a right side of the mesh rectangle; and
stretching the first stretchable cord and the second stretchable cord to allow a user to tightly fasten the first communicating hook and the second communicating hook to the third hole and the fourth hole.

2. The protective screen of claim 1, further comprising holding the top of the mesh rectangle and the bottom of the mesh rectangle via the first stretchable cord and the second stretchable cord such that the left pole of the golf cart and the right pole of the golf cart are gripped.

3. The protective screen of claim 2, further comprising holding the left pole of the golf cart and the right pole of the golf cart in a fixed position such that the mesh rectangle remains taught upon outside pressure.

4. The protective screen of claim 1, further comprising holding the left pole of the golf cart and the right pole of the golf cart in a fixed position such that the mesh rectangle remains taught upon outside pressure.

5. The protective screen of claim 1, further comprising strengthening edges of the mesh rectangle in a taught position, the edges secured with the left stretchable cord and the right stretchable cord.

6. The protective screen of claim 2, further comprising adjusting elasticity of the left stretchable cord and the right stretchable cord to adapt to varying widths of the left pole and the right pole of the golf cart.

7. The protective screen of claim 1, further comprising adjusting elasticity of the left stretchable cord and the right stretchable cord to adapt to varying widths of the left pole and the right pole of the golf cart.

8. A protective screen, comprising:
feeding a first stretchable cord and a second stretchable cord through a first hole and a second hole, respectively, at two corners of a mesh rectangle;
forming the first stretchable cord and the second stretchable cord to be configured to hold a first communicating hook and a second communicating hook;
fitting the mesh rectangle to a golf cart by hooking the first communicating hook around the poles of the golf cart along the back of the mesh rectangle to a third hole disposed opposite the first hole;
fitting the second communicating hook around poles of the golf cart along a back of the mesh rectangle to a fourth hole disposed opposite the second hole;
screening occupants of a golf cart from hazards and nuisances impeding on the immediate space at the front of the golf cart;
closing the first hook and the second hook with a first loop fastener and a second loop fastener in a secure fashion around a middle of the poles of a golf cart;
securing the first stretchable cords, the second stretchable cord, the first communicating hook, the second communicating hook, the first hook, the second hook and loop fasteners to the insect screen in a tight manner around the top, a bottom and left side and a right side of the mesh rectangle;
stretching the first stretchable cord and the second stretchable cord to allow a user to tightly fasten the first communicating hook and the second communicating hook to the third hole and the fourth hole;
further comprising holding the top of the mesh rectangle and the bottom of the mesh rectangle via the first stretchable cord and the second stretchable cord such that the left pole of the golf cart and the right pole of the golf cart are gripped;
further comprising holding the left pole of the golf cart and the right pole of the golf cart in a fixed position such that the mesh rectangle remains taught upon outside pressure;
further comprising holding the left pole of the golf cart and the right pole of the golf cart in a fixed position such that the mesh rectangle remains taught upon outside pressure;
further comprising strengthening edges of the mesh rectangle in a taught position, the edges secured with the left stretchable cord and the right stretchable cord; and
further comprising adjusting elasticity of the left stretchable cord and the right stretchable cord to adapt to varying widths of the left pole and the right pole of the golf cart.
